(19) United States
(12) Patent Application Publication
(10) Pub. No.: US 2024/0175999 A1
(43) Pub. Date: May 30, 2024

(54) OPTICAL ELEMENT DAMAGE DETECTION INCLUDING ULTRASONIC EMTTER AND DETECTOR

(71) Applicant: Continental Autonomous Mobility US, LLC, Auburn Hills, MI (US)

(72) Inventors: Octavio Samano Cancino, Oxnard, CA (US); Goran Vuletici, Ingolstadt (DE); Lukasz Koczwara, Schaumburg, IL (US)

(73) Assignee: Continental Autonomous Mobility US, LLC, Auburn Hills, MI (US)

(21) Appl. No.: 18/060,371

(22) Filed: Nov. 30, 2022

(51) Int. Cl. G01S 7/497; G01N 29/07; G01N 29/34; G01N 29/36; G01N 29/44; G01S 17/86

(52) U.S. Cl. CPC G01S 7/497; G01N 29/07; G01N 29/343; G01N 29/36; G01N 29/4454; G01S 17/86; G01S 17/931

(57) ABSTRACT

A LiDAR sensor includes an optical element and a light emitter aimed at the optical element. The optical element directs light from the light emitter into a field of illumination The LiDAR sensor includes a light detector having a field of view overlapping the field of illumination. An ultrasonic transmitter and ultrasonic receiver are on the optical element. A method of operating the LiDAR sensor includes controlling operation of the light emitter based on characteristics of the detected sound from the ultrasonic transmitter.

### BACKGROUND

A non-scanning LiDAR (Light Detection And Ranging) sensor, e.g., a solid-state LADAR sensor includes a photodetector, or an array of photodetectors, that is fixed in place relative to a carrier, e.g., a vehicle. Light is emitted into the field of view of the photodetector and the photodetector detects light that is reflected by an object in the field of view, conceptually modeled as a packet of photons. For example, a Flash LADAR sensor emits pulses of light, e.g., laser light, into the entire field of view. The detection of reflected light is used to generate a three-dimensional (3D) environmental map of the surrounding environment. The time of flight of reflected photons detected by the photodetector is used to determine the distance of the object that reflected the light.

The LiDAR sensor may be mounted on a vehicle to detect objects in the environment surrounding the vehicle and to detect distances of those objects for environmental mapping. The output of the LiDAR sensor may be used, for example, to autonomously or semi-autonomously control operation of the vehicle, e.g., propulsion, braking, steering, etc. Specifically, the LiDAR sensor may be a component of or in communication with an advanced driver-assistance system (ADAS) of the vehicle.

The LiDAR sensor may include one or more optical elements that shape and/or direct light. For example, an optical element may be or include a diffuser such as a diffractive diffuser, a refractive diffuser, etc. Specifically, the LiDAR sensor includes a light emitter aimed at the diffuser such that light travels from the light emitter, through the diffuser, and into a field of view that is external to the LiDAR sensor. The diffuser shapes and/or directs the light from the light emitter into the field of view.

### BRIEF DESCRIPTION OF THE DRAWINGS

FIG. 1 is a perspective view of a vehicle including a LiDAR sensor.

FIG. 2 is a perspective view of the LiDAR sensor.

FIG. 3 is a cut-away view of the LiDAR sensor

FIG. 4 is a schematic side view of the LiDAR sensor.

FIG. 5 is a perspective view of a light detector of the LiDAR assembly.

FIG. 5A is a magnified view of the light detector schematically showing an array of photodetectors.

FIG. 6 is a block diagram of the LiDAR sensor.

FIG. 7 is a perspective view of an optical element of the LiDAR sensor, an ultrasonic transmitter and ultrasonic receiver on the optical element, and a schematic representation of sound waves emitted from the ultrasonic transmitter.

FIG. 8 is a side view of the optical element with a schematic representation of the sound waves.

FIG. 9 is the perspective view of FIG. 7 with a crack in the optical element.

FIG. 10 is the side view of FIG. 8 with a crack in the optical element.

FIG. 11 is a block diagram of a method of operating the LiDAR sensor.

### DETAILED DESCRIPTION

With reference to the Figures, wherein like numerals indicate like parts throughout the several views, a LiDAR sensor 10 includes an optical element 36, 38 and a light emitter 14 aimed at the optical element 36, 38. The optical element 36, 38 directs light from the light emitter 14 into a field of illumination. A light detector 16 has a field of view overlapping the field of illumination. An ultrasonic transmitter 18 is on the optical element 36, 38 and an ultrasonic receiver 20 is on the optical element 36, 38.

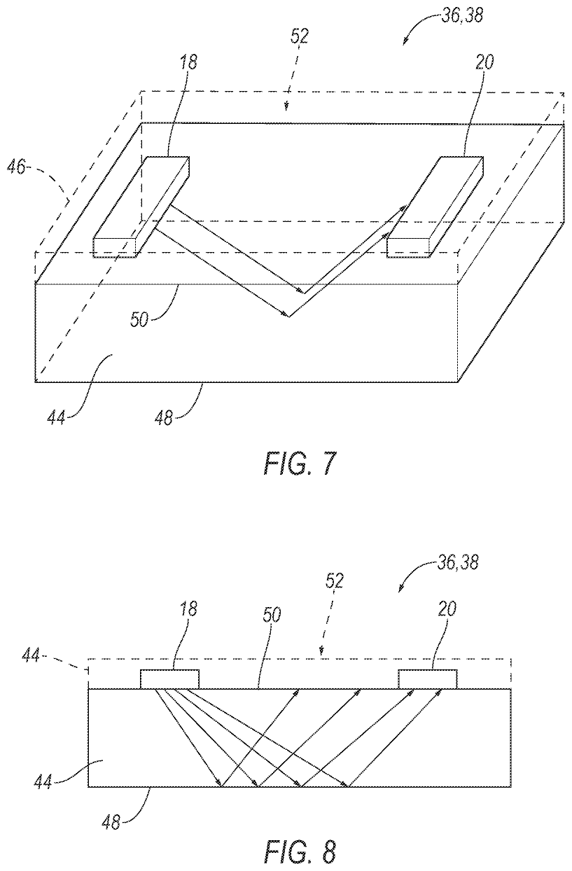

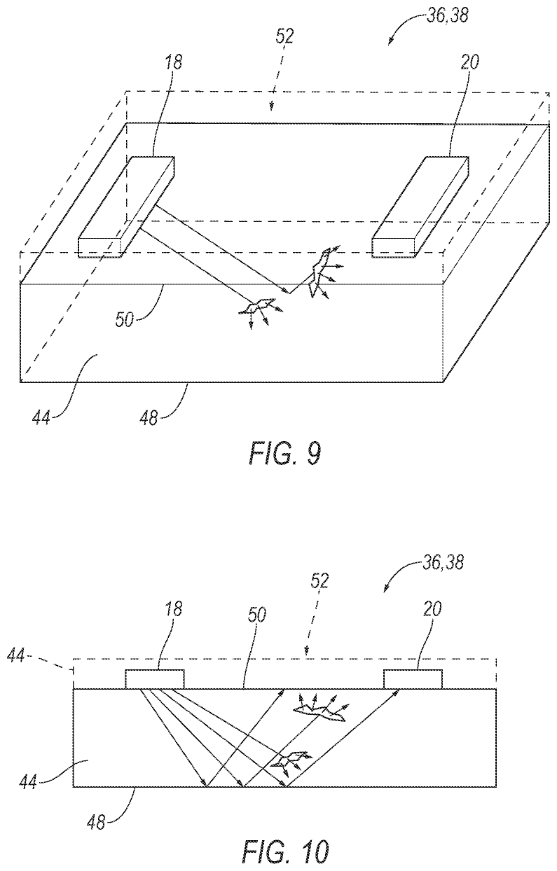

The ultrasonic transmitter 18 transmits sound into the optical element 36, 38 and the ultrasonic receiver 20 detects the sound emitted by the ultrasonic transmitter 18 through the optical element 36, 38. The integrity of the optical element 36, 38 may be determined based on the characteristics of the sound detected by the ultrasonic receiver 20. Specifically, with reference to FIGS. 7 and 8, when the sound (schematically shown) is uninterrupted from the ultrasonic transmitter 18 to the ultrasonic receiver 20, the sound echoes through the optical element 36, 38 indicating that the optical element 36, 38 is intact, i.e., not damaged. With reference to FIGS. 9 and 10, when the sound (schematically shown) is interrupted by a damaged area of the optical element 36, 38, e.g., a crack, the sound is scattered resulting impulse noise. The transmission of the sound though the optical element 36, 38 and the detection of that sound is used to determine whether the optical element 36, 38 is damaged or undamaged and the light emitter 14 is disabled in response to a determination of damage to the optical element 36, 38 to prevent emission of light at undesired intensity from the LiDAR sensor 10. This transmission and detection of sound may be repeated to monitor the integrity of the optical element 36, 38.

A method 1100 of operating the LiDAR sensor 10 includes emitting sound from the ultrasonic transmitter 18 on the optical element 36, 38, detecting sound emitted from the ultrasonic transmitter 18 with the ultrasonic receiver 20 on the optical element 36, 38; and controlling operation of the light emitter 14 aimed at the optical element 36, 38 based on characteristics of the detected sound from the ultrasonic transmitter 18. Specifically, the characteristics of the sound may be the echo of sound emitted by the ultrasonic transmitter 18 through the optical element 36, 38 when the optical element 36, 38 is intact and/or impulse noise from sound emitted by the ultrasonic transmitter 18 and scattered by a damaged area of the optical element 36, 38, e.g., a crack. With the method 1100, the integrity of the optical element 36, 38 may be determined and the light emitter 14 may be disabled in response to a determination of damage to the optical element 36, 38 to prevent emission of light at undesired intensity from the LiDAR sensor 10. This method 1100 may be repeated to monitor the integrity of the optical element 36, 38.

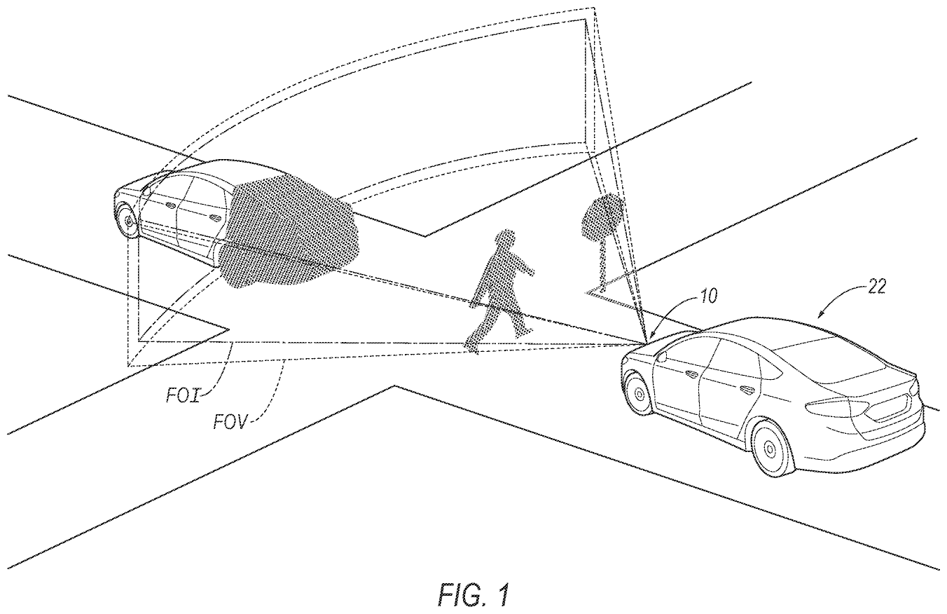

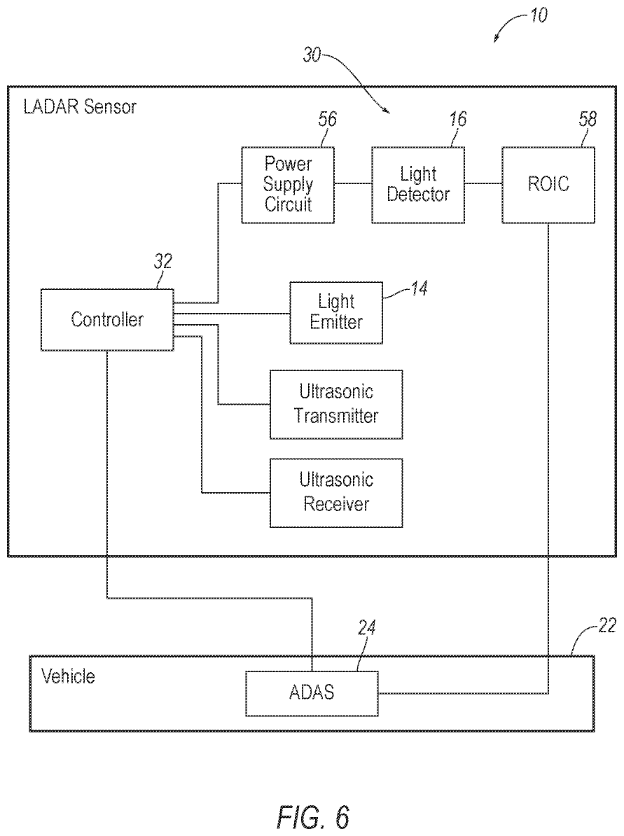

The LiDAR sensor 10 is shown in FIG. 1 as being mounted on a vehicle 22. In such an example, the LiDAR sensor 10 is operated to detect objects in the environment surrounding the vehicle 22 and to detect distance, i.e., range, of those objects for environmental mapping. The output of the LiDAR sensor 10 may be used, for example, to autonomously or semi-autonomously control operation of the vehicle 22, e.g., propulsion, braking, steering, etc. Specifically, the LiDAR sensor 10 may be a component of or in communication with an advanced driver-assistance system (ADAS) 24 of the vehicle 22 (FIG. 6). The LiDAR sensor 10 may be mounted on the vehicle 22 in any suitable position and aimed in any suitable direction. As one example, the LiDAR sensor 10 is shown on the front of the vehicle 22 and directed forward. The vehicle 22 may have more than one LiDAR sensor 10 and/or the vehicle 22 may include other object detection systems, including other LiDAR systems. The vehicle 22 shown in the figures is a passenger automobile. As other examples, the vehicle 22 may be of any suitable manned or un-manned type including a plane, satellite, drone, watercraft, etc.

The LiDAR sensor 10 may be a non-scanning sensor. For example, the LiDAR sensor 10 may be a solid-state LiDAR. In such an example, the LiDAR sensor 10 is stationary relative to the vehicle in contrast to a mechanical LiDAR, also called a rotating LiDAR, that rotates 360 degrees. The solid-state LiDAR sensor, for example, may include a casing 26 that is fixed relative to the vehicle, i.e., does not move relative to the component of the vehicle to which the casing 26 is attached, and components of the LiDAR sensor 10 are supported in the casing 26. As a solid-state LiDAR, the LiDAR sensor 10 may be a flash LiDAR sensor. In such an example, the LiDAR sensor 10 emits pulses, i.e., flashes, of light into a field of illumination FOI. More specifically, the LiDAR sensor 10 may be a 3D flash LiDAR sensor 10 that generates a 3D environmental map of the surrounding environment. In a flash LiDAR sensor 10, the FOI illuminates a field of view FOV of the light detector 16. Another example of solid-state LiDAR includes an optical-phase array (OPA). Another example of solid-state LiDAR is a micro-electromechanical system (MEMS) scanning LiDAR, which may also be referred to as a quasi-solid-state LiDAR.

The LiDAR sensor 10 emits infrared light and detects (i.e., with photodetectors 54) the emitted light that is reflected by an object in the field of view FOV, e.g., pedestrians, street signs, vehicles, etc. Specifically, the LiDAR sensor 10 includes a light-emission system 28, a light-receiving system 30, and a controller 32 that controls the light-emission system 28 and the light-receiving system 30. The LiDAR sensor 10 also detects ambient visible light reflected by an object in the field of view FOV (i.e., with photodetectors 54).

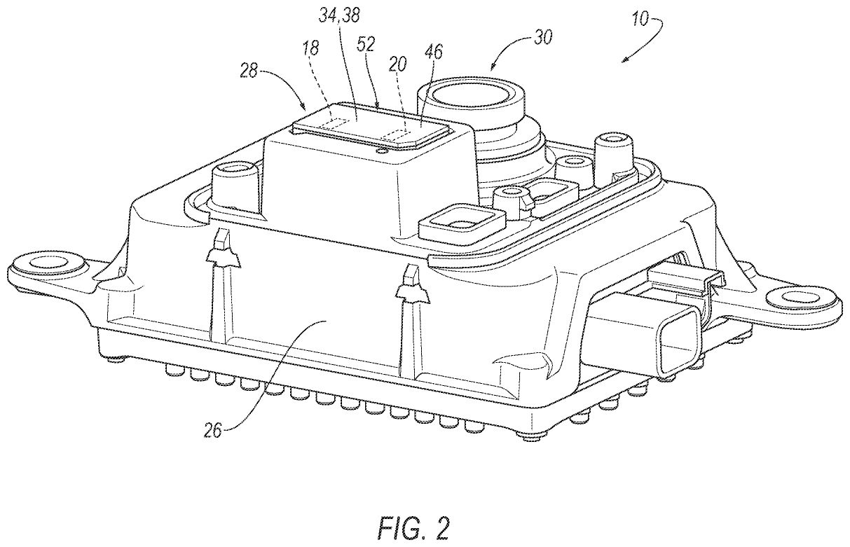

With reference to FIGS. 2-4, the LiDAR sensor 10 may be a unit. Specifically, the casing 26 supports the light-emission system 28 and the light-receiving system 30. The casing 26 may enclose the light-emission system 28 and the light-receiving system 30. The casing 26 may include mechanical attachment features to attach the casing 26 to the vehicle 22 and electronic connections to connect to and communicate with electronic system of the vehicle, e.g., components of the ADAS. At least one exit window 34 extends through the casing 26. Specifically, the casing 26 includes an aperture and the exit window 34 extends across the aperture. The casing 26, for example, may be plastic or metal and may protect the other components of the LiDAR sensor 10 from moisture, environmental precipitation, dust, etc. In the alternative to the LiDAR sensor 10 being a unit, components of the LiDAR sensor 10, e.g., the light-emission system 28 and the light-receiving system 30, may be separated and disposed at different locations of the vehicle 22.

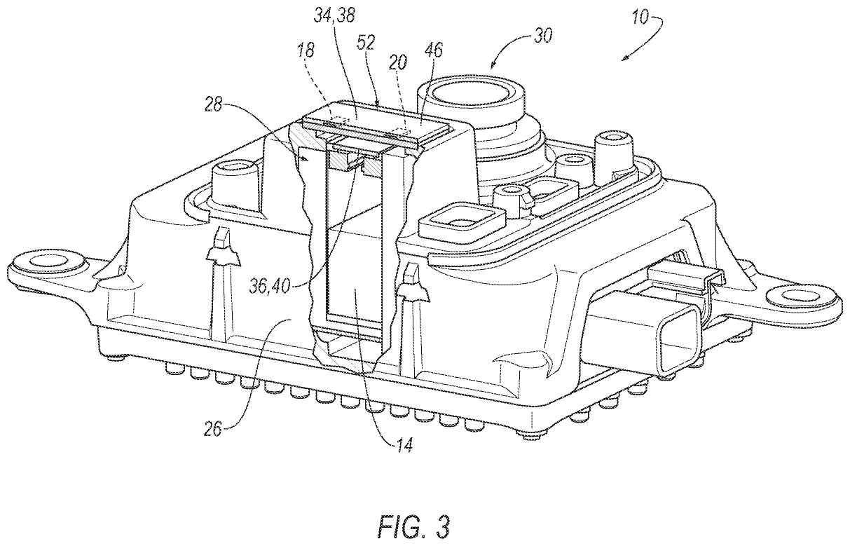

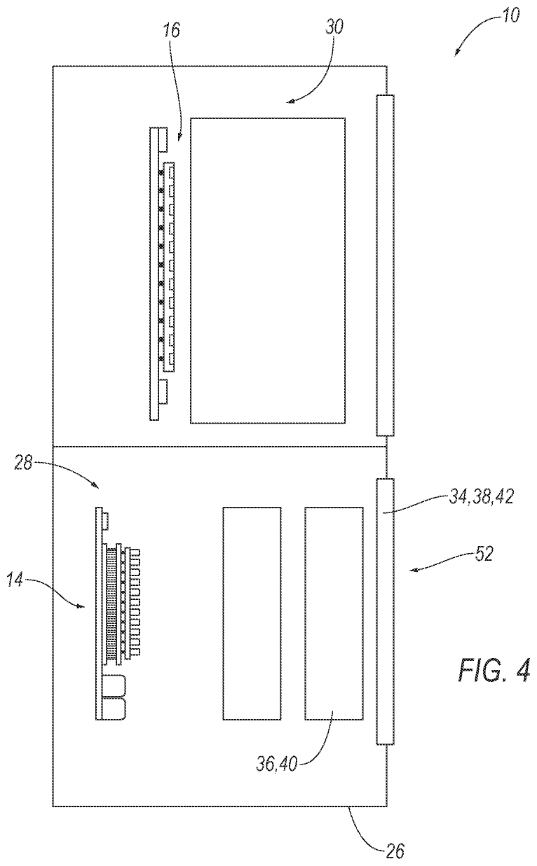

With reference to FIGS. 3-4, the light-emission system 28 may include one or more light emitter 14 and optical components such as a lens package, lens crystal, pump delivery optics, etc. The optical components are between the light emitter 14 and the exit window 34. Thus, light emitted from the light emitter 14 passes through the optical components before exiting the casing 26 through the exit window 34. The optical components include at least one optical element 12 and may include, for example, a collimating lens, transmission optics, etc. The optical components direct, focus, and/or shape the light into the field of illumination FOI.

In the example shown in the figures, the LiDAR sensor 10 includes a first optical element 36 and a second optical element 38. In the example shown in the figures, the exit window 34 is the second optical element 38. As described further below, the first optical element 36 and the second optical element 38 may both be diffusers, i.e., the first optical element 36 is a first diffuser 40 and the second optical element 38 is a second diffuser 42. The adjectives “first” and “second” are used to distinguish between the two optical element 12s and the adjectives do not signify order or importance. In examples including more than one optical element 12, the optical element 36, 38s may be of the same type of different types. Common numerals are used to identify common features of the first optical element 36 and the second optical element 38.

The light emitter 14 is aimed at the optical element 36, 38, i.e., substantially all of the light emitted from the light emitter 14 reaches the optical element 36, 38. The optical element 36, 38 directs the shapes light for illuminating the field of illumination FOI exterior to the LiDAR sensor 10. In other words, the optical element 36, 38 is designed to direct the shaped light to the exit window 34, i.e., is sized, shaped, positioned, and/or has optical characteristics to direct the shape light. As an example, the optical element 36, 38 may be designed to shape the light from the light emitter 14 to be in an elongated pattern into the field of illumination FOI. As one example of shaping the light, the optical element 36, 38 diffuses the light, i.e., spreads the light over a larger path and reduces the concentrated intensity of the light. In other words, in such an example, the optical element 36, 38 is a diffuser that is designed to diffuse the light from the light emitter 14. Light from the light emitter 14 may travel directly from the light emitter 14 to the optical element 36, 38 or may interact with additional components between the light emitter 14 and the optical element 36, 38. The shaped light from the optical element 36, 38 may travel directly to the exit window 34 or may interact with additional components between the optical element 36, 38 the exit window 34 before exiting the exit window 34 into the field of illumination FOI.

The optical element 36, 38 may be of any suitable type that shapes and directs light from the light emitter 14 toward the exit window 34. For example, the optical element 36, 38 may be or include a diffractive optical element 12, a diffractive diffuser, a refractive diffuser, etc. The optical element 36, 38 is transmissive. In other words, light from the light emitter 14 transmits through the optical element 36, 38. In such an example, the optical element 36, 38 may be transparent.

In the example shown in the figures in which the first optical element 36 is a first diffuser 40 and the second optical element 38 is a second diffuser 42, light from the light emitter 14 travels through the first diffuser 40 before traveling through the second diffuser 42. The first diffuser 40 diffuses the light and directs the light, either directly or indirectly, to the second diffuser 42. The second diffuser 42 diffuses the light and, in the example in the figures in which the second optical element 38 i.e., the second diffuser 42, is the exit window 34, the second diffuser 42 directs the light into the field of illumination exterior to the LiDAR sensor 10. The first optical element 36 may be spaced from the second optical element 38, as shown in in the example in the figures.

The ultrasonic transmitter 18 and/or the ultrasonic receiver 20 may be encapsulated on the optical element 36, 38. In the example shown in the figures, the ultrasonic transmitter 18 and the ultrasonic receiver 20 are encapsulated on the second optical element 38. In other examples, the ultrasonic transmitter 18 and the ultrasonic receiver 20 may be encapsulated on the first optical element 36 in addition or in the alternative to the ultrasonic transmitter 18 and the ultrasonic receiver 20 being encapsulated on the second optical element 38. In such examples, one set of ultrasonic transmitter 18 and ultrasonic receiver 20 is encapsulated on one optical element 12 and another set of ultrasonic transmitter 18 and ultrasonic receiver 20 is encapsulated on the other optical element 12.

The optical element 36, 38 may include a base layer 44 and a second layer 46 encapsulating the ultrasonic transmitter 18 and the ultrasonic receiver 20 on the base layer 44. The base layer 44 may be polymeric. As one example, the base layer 44 may be polycarbonate or any other suitable type of polymeric material. As other examples, the base layer 44 may be glass or any other suitable type of material. The second layer 46 may be polymeric. As an example, the second layer 46 may be polycarbonate or any other suitable polymeric material that can be applied to the base layer 44 to encapsulate the ultrasonic transmitter 18 and the ultrasonic receiver 20 on the base layer 44. The second layer 46 may be applied to the base layer 44 by, for example, over-molding. In such an example, the optical element 36, 38 is over-molded, specifically, the second layer 46 is over-molded. “Over-molded” is a structural description optical element 12 and the second layer 46, not the process by which the optical element 36, 38 and the second layer 46 is made. In other words, the over-molded optical element 12 and second layer 46 has the structure of an over-molded component. When over-molded, the second layer 46 may be a single, uniform piece of material with no seams or joints and may be fixed to the base layer 44 without fasteners or adhesives holding the second layer 46 and the base layer 44 together. In such an example, the second layer 46 has a shape that conforms to a mold, e.g., an injection mold, used to form the second layer 46 as an over-molded component to the base layer 44. In other examples, the second layer 46 is not over-molded and is fixed to the base layer 44 by fusing, adhesive, etc.

In the example shown in the figures, the base layer 44 has an inboard side 48 and the outboard side 50. The second layer 46 may be on the outboard side 50, as shown in the example in the figures. As set forth further below, the ultrasonic transmitter 18 and the ultrasonic receiver 20 are on the outboard side 50 and the second layer 46 encapsulates the ultrasonic transmitter 18 and the ultrasonic receiver 20 on the outboard side 50.

The optical element 36, 38 includes a light-shaping region 52. The light emitter 14 is aimed at the light-shaping region 52, i.e., directly or indirectly as described above. The light-shaping region 52 of the optical element 36, 38 shapes light that is emitted from the light emitter 14. As one example of shaping the light, the light-shaping region 52 of the optical element 36, 38 diffuses the light, i.e., spreads the light over a larger path and reduces the concentrated intensity of the light. In other words, the light-shaping region 52 of the optical element 36, 38 is designed to diffuse the light from the light emitter 14.

The light-emission system 28 includes the ultrasonic transmitter 18 and the ultrasonic receiver 20. As set forth above, the ultrasonic transmitter 18 and the ultrasonic receiver 20 are on the optical element 36, 38. The ultrasonic transmitter 18 emits ultrasound, i.e., sound in the ultrasonic range, and the ultrasonic receiver 20 detects ultrasound. Specifically, the ultrasonic transmitter 18 converts an electrical signal input into emission of ultrasound and the ultrasonic receiver 20 coverts ultrasound to an electrical signal output. The controller 32 may control the ultrasonic transmitter 18, i.e., by providing the electrical signal input, and the controller 32 may receive information from the ultrasonic receiver 20, i.e., by receiving the electrical signal output from the ultrasonic receiver 20. The ultrasonic transmitter 18 and the ultrasonic receiver 20 may be connected to the controller 32, directly or indirectly, in any suitable manner including wired electrical connection.

The ultrasonic transmitter 18 emits ultrasound into the optical element 36, 38 and the ultrasonic receiver 20 receives the ultrasound emitted by the ultrasonic transmitter 18. As described further below, the controller 32 controls operation of the light emitter 14 based on characteristics of the sound from the ultrasonic transmitter 18 detected by the ultrasonic receiver 20. Specifically, the controller 32 continues operation of the light emitter 14, i.e., emits light from the light emitter 14, when the ultrasound detected by the ultrasonic receiver 20 indicates that the optical element 36, 38 is intact, i.e., undamaged, and the controller 32 disables the light emitter 14 when the ultrasound detected by the ultrasonic receiver 20 indicates that the optical element 36, 38 is damaged, e.g., cracked.

The ultrasonic transmitter 18 and the ultrasonic receiver 20 are on the optical element 36, 38, e.g., encapsulated on the optical element 36, 38 as described above. In the example shown in the figures, the ultrasonic transmitter 18 and the ultrasonic receiver 20 are on the second optical element 38. In other examples, the ultrasonic transmitter 18 and the ultrasonic receiver 20 may be on the first optical element 36 in addition or in the alternative to the ultrasonic transmitter 18 and the ultrasonic receiver 20 being on the second optical element 38. In such examples, one set of ultrasonic transmitter 18 and ultrasonic receiver 20 is on one optical element 12 and another set of ultrasonic transmitter 18 and ultrasonic receiver 20 is on the other optical element 12.

The ultrasonic transmitter 18 may be spaced from the ultrasonic receiver 20. In such an example, the light-shaping region 52 is between the ultrasonic transmitter 18 and the ultrasonic receiver 20 so that ultrasound from the ultrasonic transmitter 18 travels through the light-shaping region 52 to the ultrasonic receiver 20. Accordingly, damage in the light-shaping region 52 changes the characteristics of the ultrasound, which is detected by the ultrasonic receiver 20 to identify the damage, as described further below. In such an example, the ultrasonic transmitter 18 is aimed at the light-shaping region 52, i.e., directly or indirectly. As another example, ultrasonic transmitter 18 and the ultrasonic receiver 20 may be adjacent. For example, a single component may be both the ultrasonic transmitter 18 and ultrasonic receiver 20, i.e., an ultrasonic transducer.

In the example shown in the figures, the ultrasonic transmitter 18 and the ultrasonic receiver 20 are aimed through the optical element 36, 38. The ultrasonic transmitter 18 and the ultrasonic receiver 20 may be on the same side of the optical element 36, 38 and aimed at the opposite side of the optical element 36, 38. In the example shown in the figures, the ultrasonic transmitter 18 and the ultrasonic receiver 20 on the outboard side 50 and are aimed at the inboard side 48. As another example, the ultrasonic transmitter 18 and the ultrasonic receiver 20 may be on the inboard side 48 and aimed at the outboard side 50.

The ultrasound from the ultrasonic transmitter 18 is internally reflected from the opposite side of the optical element 36, 38 (the inboard side 48 in the example in the figures) toward the ultrasonic receiver 20 when the optical element 36, 38 is intact. In other words, the ultrasound echoes from the opposite side and is detected by the ultrasonic receiver 20. Detection by the ultrasonic receiver 20 of the echo of the ultrasound emitted by the ultrasonic transmitter 18 indicates that the optical element 36, 38 is intact. Specifically, the echo is the repetition of sound caused by reflection of sound waves. As the ultrasound travels through the consistent medium of the intact optical element 12, the ultrasound travels to the opposite side uninterrupted by damage of the optical element 36, 38, is reflected by the opposite side, and travels to the ultrasonic receiver 20 uninterrupted by damage of the optical element 36, 38. The receipt of this echo indicates that the optical element 36, 38 is intact.

Detection by the ultrasonic receiver 20 of impulse noise generated by emission of ultrasound by the ultrasonic transmitter 18 indicates that the optical element 36, 38 is damaged. The ultrasound emitted by the ultrasonic transmitter 18 is disrupted by damage to the optical element 36, 38, e.g., a crack, which generates impulse noise. Specifically, as the ultrasound emitted by the ultrasonic transmitter 18 travels through the optical element 36, 38, the ultrasound is scattered when the ultrasound reaches a crack in the optical element 36, 38. This scattering of the ultrasound generates impulse noise detected by the ultrasonic receiver 20. Thus, the detection of the impulse noise by the ultrasonic receiver 20 indicates damage to the optical element 36, 38.

Characteristics of the impulse noise indicate the severity of damage to the optical element 36, 38. For example, impulse noise above a predetermined frequency detected by the ultrasonic receiver 20 indicates that the damage to the optical element 36, 38 is of the severity that the light emitter 14 is disabled. Likewise, impulse noise below the predetermined frequency indicates that any damage to the optical element 36, 38 is not of sufficient severity to disable the light emitter 14. As set forth below, the controller 32 disables the light emitter 14 when the ultrasonic receiver 20 detects impulse noise above the predetermined frequency and the controller 32 activates the light emitter 14 when the ultrasonic receiver 20 detects the echo or impulse noise below the predetermined frequency. The predetermined frequency may be determined by modeling, empirical data, etc. Specifically, the predetermined frequency is based on the amount of damage to the optical element 36, 38 that would result in potential emission of light from the LiDAR sensor 10 at undesired intensity. Specifically, impulse noise above the predetermined frequency indicates that the optical element 36, 38 is damaged with the severity that results in emission of light from the LiDAR sensor 10 at undesired intensity when the light emitter 14 is activated. Impulse noise below the predetermined frequency indicates that the optical element 36, 38 is intact or damaged at a relatively low severity such that emission of light from the LiDAR sensor 10 is within desired intensity range, e.g., the damage to the optical element 36, 38 does not hinder the suitable diffusion of light from the light emitter 14 into the field of illumination FOI.

The light emitter 14 emits light for illuminating objects for detection. The light-emission system 28 may include a beam-steering device (not shown) between the light emitter 14 and the window. The controller 32 is in communication with the light emitter 14 for controlling the emission of light from the light emitter 14 and, in examples including a beam-steering device, the controller 32 is in communication with the beam-steering device for aiming the emission of light from the LiDAR sensor 10 into the field of illumination FOI.

The light emitter 14 emits light into the field of illumination FOI for detection by the light-receiving system 30 when the light is reflected by an object in the field of view FOV. In the example in which the LiDAR sensor 10 is flash LiDAR, the light emitter 14 emits shots, i.e., pulses, of light into the field of illumination FOI for detection by the light-receiving system 30 when the light is reflected by an object in the field of view FOV to return photons to the light-receiving system 30. Specifically, the light emitter 14 emits a series of shots. As an example, the series of shots may be 1,500-2,500 shots. The light-receiving system 30 has a field of view FOV that overlaps the field of illumination FOI and receives light reflected by surfaces of objects, buildings, road, etc., in the FOV. In other words, the light-receiving system 30 detects shots emitted from the light emitter 14 and reflected in the field of view FOV back to the light-receiving system 30, i.e., detected shots. The light emitter 14 may be in electrical communication with the controller 32, e.g., to provide the shots in response to commands from the controller 32.

The light emitter 14 may be, for example, a laser. The light emitter 14 may be, for example, a semiconductor light emitter 14, e.g., laser diodes. In one example, the light emitter 14 is a vertical-cavity surface-emitting laser (VCSEL). As another example, the light emitter 14 may be a diode-pumped solid-state laser (DPSSL). As another example, the light emitter 14 may be an edge emitting laser diode. The light emitter 14 may be designed to emit a pulsed flash of light, e.g., a pulsed laser light. Specifically, the light emitter 14, e.g., the VCSEL or DPSSL or edge emitter, is designed to emit a pulsed laser light or train of laser light pulses. In examples in which the first optical element 36 and the second optical element 38 are diffusers, the light emitted by the light emitter 14 is diffused by the first optical element 36 and the second optical, as described above. The light emitted by the light emitter 14 may be, for example, infrared light. Alternatively, the light emitted by the light emitter 14 may be of any suitable wavelength. The LiDAR sensor 10 may include any suitable number of light emitter 14s, i.e., one or more in the casing 26. In examples that include more than one light emitter 14, the light emitter 14s may be arranged in a column or in columns and rows. In examples that include more than one light emitter 14, the light emitter 14s may be identical or different and may each be controlled by the controller 32 for operation individually and/or in unison.

As set forth above, the light emitter 14 is aimed, directly or indirectly, at the optical element 36, 38, and more specifically, at the first optical element 36 and the second optical element 38 in the example shown in the figures. The light emitter 14 may be stationary relative to the casing 26. In other words, the light emitter 14 does not move relative to the casing 26 during operation of the LiDAR sensor 10, e.g., during light emission. The light emitter 14 may be mounted to the casing 26 in any suitable fashion such that the light emitter 14 and the casing 26 move together as a unit.

The light-receiving system 30 has a field of view FOV that overlaps the field of illumination FOI and receives light reflected by objects in the FOV. Stated differently, the field of illumination FOI generated by the light-emitting system overlaps the field of view of the light-receiving system 30. The light-receiving system 30 may include receiving optics and a light detector 16 having the array of photodetectors 54. The light-receiving system 30 may include a receiving window and the receiving optics may be between the receiving window and the light detector 16. The receiving optics may be of any suitable type and size.

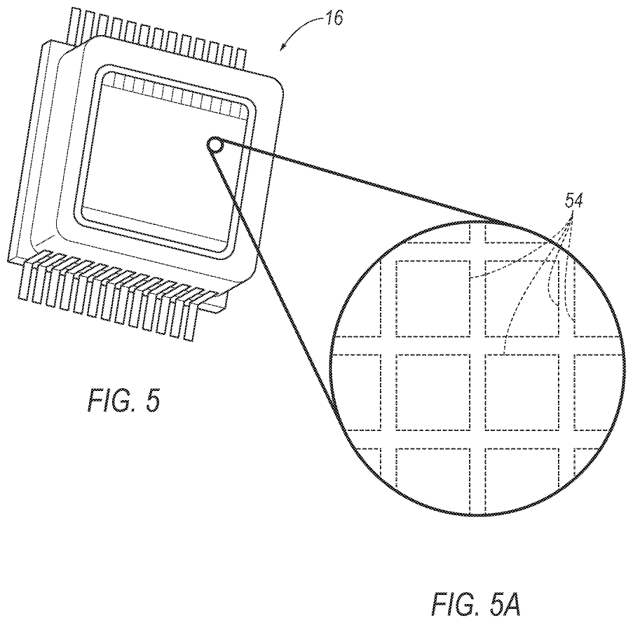

The light detector 16 includes a chip and the array of photodetectors 54 is on the chip, as described further below. The chip may be silicon (Si), indium gallium arsenide (InGaAs), germanium (Ge), etc., as is known. The chip and the photodetectors 54 are shown schematically. The array of photodetectors 54 is 2-dimensional. Specifically, the array of photodetectors 54 includes a plurality of photodetectors 54 arranged in a columns and rows (schematically shown in FIGS. 5 and 5A).

Each photodetector 54 is light sensitive. Specifically, each photodetector 54 detects photons by photo-excitation of electric carriers. An output signal from the photodetector 54 indicates detection of light and may be proportional to the amount of detected light. The output signals of each photodetector 54 are collected to generate a scene detected by the photodetector 54.

The photodetector 54 may be of any suitable type, e.g., photodiodes (i.e., a semiconductor device having a p-n junction or a p-i-n junction) including avalanche photodiodes (APD), a single-photon avalanche diode (SPAD), a PIN diode, metal-semiconductor-metal photodetectors 54, phototransistors, photoconductive detectors, phototubes, photomultipliers, etc. The photodetectors 54 may each be of the same type.

Avalanche photo diodes (APD) are analog devices that output an analog signal, e.g., a current that is proportional to the light intensity incident on the detector. APDs have high dynamic range as a result but need to be backed by several additional analog circuits, such as a transconductance or transimpedance amplifier, a variable gain or differential amplifier, a high-speed A/D converter, one or more digital signal processors (DSPs) and the like.

In examples in which the photodetectors 54 are SPADs, the SPAD is a semiconductor device, specifically, an APD, having a p-n junction that is reverse biased (herein referred to as “bias”) at a voltage that exceeds the breakdown voltage of the p-n junction, i.e., in Geiger mode. The bias voltage is at a magnitude such that a single photon injected into the depletion layer triggers a self-sustaining avalanche, which produces a readily-detectable avalanche current. The leading edge of the avalanche current indicates the arrival time of the detected photon. In other words, the SPAD is a triggering device of which usually the leading edge determines the trigger.

The SPAD operates in Geiger mode. “Geiger mode” means that the APD is operated above the breakdown voltage of the semiconductor and a single electron-hole pair (generated by absorption of one photon) can trigger a strong avalanche. The SPAD is biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by a power-supply circuit 56 to a voltage above the SPAD breakdown voltage so that the next photon can be detected.

Each photodetector 54 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the field of view FOVs. By merging these distances with the position of photodetectors 54 at which these data originated and relative positions of these photodetectors 54 at a time that these data were collected, the LiDAR sensor 10 (or other device accessing these data) can reconstruct a three-dimensional (virtual or mathematical) model of a space occupied by the LiDAR sensor 10, such as in the form of 3D image represented by a rectangular matrix of range values, wherein each range value in the matrix corresponds to a polar coordinate in 3D space. Each photodetector 54 can be configured to detect a single photon per sampling period, e.g., in the example in which the photodetector 54 is a SPAD. The photodetector 54 functions to output a single signal or stream of signals corresponding to a count of photons incident on the photodetector 54 within one or more sampling periods. Each sampling period may be picoseconds, nanoseconds, microseconds, or milliseconds in duration. The photodetector 54 can output a count of incident photons, a time between incident photons, a time of incident photons (e.g., relative to an illumination output time), or other relevant data, and the LiDAR sensor 10 can transform these data into distances from the LiDAR sensor 10 to external surfaces in the fields of view of these photodetectors 54. By merging these distances with the position of photodetectors 54 at which these data originated and relative positions of these photodetectors 54 at a time that these data were collected, the controller 32 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

With reference to FIGS. 5 and 5A, the photodetectors 54 may be arranged as an array, e.g., a 2-dimensional arrangement. A 2D array of photodetectors 54 includes a plurality of photodetectors 54 arranged in columns and rows. Specifically, the light detector 16 may be a focal-plane array (FPA).

The light detector 16 includes a plurality of pixels. Each pixel may include one or more photodetectors 54. The pixels each including a power-supply circuit 56 and a read-out integrated circuit (ROIC 58). The photodetectors 54 are connected to the power-supply circuit 56 and the ROIC 58. Multiple pixels may share a common power-supply circuit 56 and/or ROIC 58.

The light detector 16 detects photons by photo-excitation of electric carriers. An output from the light detector 16 indicates a detection of light and may be proportional to the amount of detected light, in the case of a PIN diode or APD, and may be a digital signal in case of a SPAD. The outputs of light detector 16 are collected to generate a 3D environmental map, e.g., 3D location coordinates of objects and surfaces within the field of view FOV of the LiDAR sensor 10.

With reference to FIG. 6, the ROIC 58 converts an electrical signal received from photodetectors 54 of the FPA to digital signals. The ROIC 58 may include electrical components which can convert electrical voltage to digital data. The ROIC 58 may be connected to the controller 32, which receives the data from the ROIC 58 and may generate 3D environmental map based on the data received from the ROIC 58.

The power-supply circuits 56 supply power to the photodetectors 54. The power-supply circuit 56 may include active electrical components such as MOSFET (Metal-Oxide-Semiconductor Field-Effect Transistor), BiCMOS (Bipolar CMOS), etc., and passive components such as resistors, capacitors, etc. As an example, the power-supply circuit 56 may supply power to the photodetectors 54 in a first voltage range that is higher than a second operating voltage of the ROIC 58. The power-supply circuit 56 may receive timing information from the ROIC 58.

The light detector 16 may include one or more circuits that generates a reference clock signal for operating the photodetectors 54. Additionally, the circuit may include logic circuits for actuating the photodetectors 54, power-supply circuit 56, ROIC 58, etc.

As set forth above, the light detector 16 includes a power-supply circuit 56 that powers the pixels. The light detector 16 may include a single power-supply circuit 56 in communication with all pixels or may include a plurality of power-supply circuit 56s in communication with a group of the pixels.

The power-supply circuit 56 may include active electrical components such as MOSFET (Metal-Oxide-Semiconductor Field-Effect Transistor), BiCMOS (Bipolar CMOS), IGBT (Insulated-gate bipolar transistor), VMOS (vertical MOSFET), HexFET, DMOS (double-diffused MOSFET) LDMOS (lateral DMOS), BJT (Bipolar junction transistor), etc., and passive components such as resistors, capacitors, etc. The power-supply circuit 56 may include a power-supply control circuit. The power-supply control circuit may include electrical components such as a transistor, logical components, etc. The power-supply control circuit may control the power-supply circuit 56, e.g., in response to a command from the controller 32, to apply bias voltage and quench and reset the SPAD.

In examples in which the photodetector 54 is an avalanche-type photodiode, e.g., a SPAD, to control the power-supply circuit 56 to apply bias voltage, quench, and reset the avalanche-type diodes, the power-supply circuit 56 may include a power-supply control circuit. The power-supply control circuit may include electrical components such as a transistor, logical components, etc. A bias voltage, produced by the power-supply circuit 56, is applied to the cathode of the avalanche-type diode. An output of the avalanche-type diode, e.g., a voltage at a node, is measured by the ROIC 58 circuit to determine whether a photon is detected. The power-supply circuit 56 supplies the bias voltage to the avalanche-type diode based on inputs received from a driver circuit of the ROIC 58. The ROIC 58 may include the driver circuit to actuate the power-supply circuit 56, an analog-to-digital (ADC) or time-to-digital (TDC) circuit to measure an output of the avalanche-type diode at the node, and/or other electrical components such as volatile memory (register), and logical control circuits, etc. The driver circuit may be controlled based on an input received from the circuit of the light detector 16, e.g., a reference clock. Data read by the ROIC 58 may be then stored in, for example, a memory chip. A controller 32, e.g., the controller 32, a controller 32 of the LiDAR sensor 10, etc., may receive the data from the memory chip and generate 3D environmental map, location coordinates of an object within the field of view FOV of the LiDAR sensor 10, etc.

The controller 32 actuates the power-supply circuit 56 to apply a bias voltage to the plurality of avalanche-type diodes. For example, the controller 32 may be programmed to actuate the ROIC 58 to send commands via the ROIC 58 driver to the power-supply circuit 56 to apply a bias voltage to individually powered avalanche-type diodes. Specifically, the controller 32 supplies bias voltage to avalanche-type diodes of the plurality of pixels of the focal-plane array through a plurality of the power-supply circuits 56, each power-supply circuit 56 dedicated to one of the pixels, as described above. The individual addressing of power to each pixel can also be used to compensate manufacturing variations via look-up-table programmed at an end-of-line testing station. The look-up-table may also be updated through periodic maintenance of the LiDAR sensor 10.

The controller 32 is in electronic communication with the pixels (e.g., with the ROIC 58 and power-supply circuit 56) and the vehicle (e.g., with the ADAS) to receive data and transmit commands. The controller 32 may be configured to execute operations disclosed herein.

The controller 32 is a physical, i.e., structural, component of the LiDAR sensor 10. The controller 32 may be a microprocessor-based controller 32, an application specific integrated circuit (ASIC), field programmable gate array (FPGA), etc., or a combination thereof, implemented via circuits, chips, and/or other electronic components.

For example, the controller 32 may include a processor, memory, etc. In such an example, the memory of the controller 32 may store instructions executable by the processor, i.e., processor-executable instructions, and/or may store data. The memory includes one or more forms of controller 32-readable media, and stores instructions executable by the controller 32 for performing various operations, including as disclosed herein. As another example, the controller 32 may be or may include a dedicated electronic circuit including an ASIC (application specific integrated circuit) that is manufactured for a particular operation, e.g., calculating a histogram of data received from the LiDAR sensor 10 and/or generating a 3D environmental map for a field of view FOV of the light detector 16 and/or an image of the field of view FOV of the light detector 16. As another example, the controller 32 may include an FPGA (field programmable gate array) which is an integrated circuit manufactured to be configurable by a customer. As an example, a hardware description language such as VHDL (very high speed integrated circuit hardware description language) is used in electronic design automation to describe digital and mixed-signal systems such as FPGA and ASIC. For example, an ASIC is manufactured based on hardware description language (e.g., VHDL programming) provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller 32 may be a set of controller 32s communicating with one another via a communication network of the vehicle, e.g., a controller 32 in the LiDAR sensor 10 and a second controller 32 in another location in the vehicle.

The controller 32 may be in communication with the communication network of the vehicle to send and/or receive instructions from the vehicle, e.g., components of the ADAS. The controller 32 is programmed to perform the method 1100 and function described herein and shown in the figures. For example, in an example including a processor and a memory, the instructions stored on the memory of the controller 32 include instructions to perform the method 1100 and function described herein and shown in the figures; in an example including an ASIC, the, the hardware description language (e.g., VHDL) and/or memory electrically connected to the circuit include instructions to perform the method 1100 and function described herein and shown in the figures; and in an example including an FPGA, the hardware description language (e.g., VHDL) and/or memory electrically connected to the circuit include instructions to perform the method 1100 and function described herein and shown in the figures. Use herein of “based on,” “in response to,” and “upon determining,” indicates a causal relationship, not merely a temporal relationship.

The controller 32 may provide data, e.g., a 3D environmental map and/or images, to the ADAS of the vehicle and the ADAS may operate the vehicle in an autonomous or semi-autonomous mode based on the data from the controller 32. For purposes of this disclosure, an autonomous mode is defined as one in which each of vehicle propulsion, braking, and steering are controlled by the controller 32 and in a semi-autonomous mode the controller 32 controls one or two of vehicle propulsion, braking, and steering. In a non-autonomous mode a human operator controls each of vehicle propulsion, braking, and steering.

The controller 32 may include or be communicatively coupled to (e.g., through the communication network) more than one processor, e.g., controller 32s or the like included in the vehicle for monitoring and/or controlling various vehicle controller 32s, e.g., a powertrain controller 32, a brake controller 32, a steering controller 32, etc. The controller 32 is generally arranged for communications on a vehicle communication network that can include a bus in the vehicle such as a controller 32 area network (CAN) or the like, and/or other wired and/or wireless mechanisms.

The controller 32 controls operation the light-emission system 28 including ultrasonic transmitter 18, the ultrasonic receiver 20, and the light emitter 14. The controller 32 may also control the operation of the light-receiving system 30 including the light detector 16.

The controller 32 is programmed to control operation of the light emitter 14 based on characteristics of sound emitted from the ultrasonic transmitter 18 and detected by the ultrasonic receiver 20. Specifically, in the example shown in the figures, detection by the ultrasonic receiver 20 of the echo of the ultrasound emitted by the ultrasonic transmitter 18 indicates that the optical element 36, 38 is intact and detection by the ultrasonic receiver 20 of impulse noise generated by emission of ultrasound by the ultrasonic transmitter 18 indicates that the optical element 36, 38 is damaged, as described above. The controller 32 is programmed to enable the light emitter 14 in response to detection of the echo by the ultrasonic receiver 20 and is programmed to disable the light emitter 14 in response to detection of impulse noise, e.g., impulse noise above a predetermined frequency, as described further below.

The controller 32 is programmed to activate the light emitter 14 to emit light into the field of illumination, as described above. Specifically, the controller 32 is programmed to enable the light emitter 14 based on detection by the ultrasonic receiver 20 of an echo of the sound generated by the ultrasonic transmitter 18. The controller 32 enables the light emitter 14, for example, by allowing activation of the light emitter 14, or providing instruction to the light emitter 14 to emit light, etc.

The controller 32 is programmed to control the operation of the ultrasonic transmitter 18 and the ultrasonic receiver 20. The controller 32 instructs the ultrasonic transmitter 18 to emit ultrasound, i.e., sound in the ultrasonic range. In response to instruction by the controller 32 to emit ultrasound, the ultrasonic transmitter 18 converts an electrical signal input into emission of ultrasound. The ultrasonic transmitter 18 is aimed at the opposite side of the optical element 36, 38 (the inboard side 48 in the example shown in the figures). The ultrasound from the ultrasonic transmitter 18 is internally reflected from the opposite side of the optical element 36, 38 (the inboard side 48 in the example in the figures) toward the ultrasonic receiver 20 when the optical element 36, 38 is intact. In other words, when the optical element 36, 38 is intact, the ultrasound echoes from the opposite side and is detected by the ultrasonic receiver 20. When the optical element 36, 38 is damaged, e.g., cracked, the damaged area of the optical element 36, 38 scatters the ultrasound generating impulse noise that is detected by the ultrasonic receiver 20.

The ultrasonic receiver 20 detects the sound generated by the ultrasonic transmitter 18, whether an echo or impulse noise. The controller 32 receives information from the ultrasonic receiver 20 indicating the detection of the noise generated by the ultrasonic transmitter 18. Specifically, the ultrasonic receiver 20 may convert the ultrasound to an electrical signal output and may communicate the electrical signal output to the controller 32.

The controller 32 programmed to disable the light emitter 14 based on detection of impulse noise by the ultrasonic receiver 20 generated from sound emitted by the sound emitter and scattered by a crack in the optical element 36, 38. The controller 32 may disable the light emitter 14, for example, by preventing activation of the light emitter 14, or deciding not to provide instructions to the light emitter 14, etc. When the light emitter 14 is disabled, the light emitter 14 does not emit light into the field of illumination of the LiDAR sensor 10. In response to disablement of the light emitter 14, the controller 32 may instruct the ADAS that the light emitter 14 is disabled.

The controller 32, more specifically, may be programmed to disable the light emitter 14 in response detection by the ultrasonic receiver 20 of sound from the ultrasonic transmitter 18 having characteristics indicating damage to the optical element 36, 38 to a severity of which the optical element 36, 38 may emit light from the light emitter 14 at an undesired intensity. For example, the controller 32 may be programmed to disable the light miter in response to detection by the ultrasonic receiver 20 of impulse noise above a predetermined threshold, e.g., the predetermined frequency as described above. In such an example, impulse noise above the predetermined frequency detected by the ultrasonic receiver 20 indicates that the damage to the optical element 36, 38 is of the severity that the light emitter 14 is disabled. Likewise, impulse noise below the predetermined frequency indicates that any damage to the optical element 36, 38 is not of sufficient severity to disable the light emitter 14.

The controller 32 may be programmed to repeat the operation of the ultrasonic transmitter 18 and the ultrasonic receiver 20 to confirm the integrity of the optical element 36, 38 before each activation of the light emitter 14, i.e., after a previous emission by the light emitter 14 and before the next emission by the light emitter 14. In other words, for each firing of the light emitter 14, the controller 32 may be programmed to first activate the ultrasonic transmitter 18 to emit sound, detect the sound with the ultrasonic receiver 20, and activate the light emitter 14 in response to identification that detection of the sound by the ultrasonic receiver 20 indicates that the optical element 36, 38 is intact. As another example, the controller 32 may periodically repeat the operation of the ultrasonic transmitter 18 and the ultrasonic receiver 20 to confirm the integrity of the optical element 36, 38 based on time, number of light emitter 14 firings, etc. In other words, the method 1100 may include repeating the operation of the ultrasonic transmitter 18 and the ultrasonic receiver 20 on regular time intervals, after a predetermined number of light emitter 14 firings, etc.

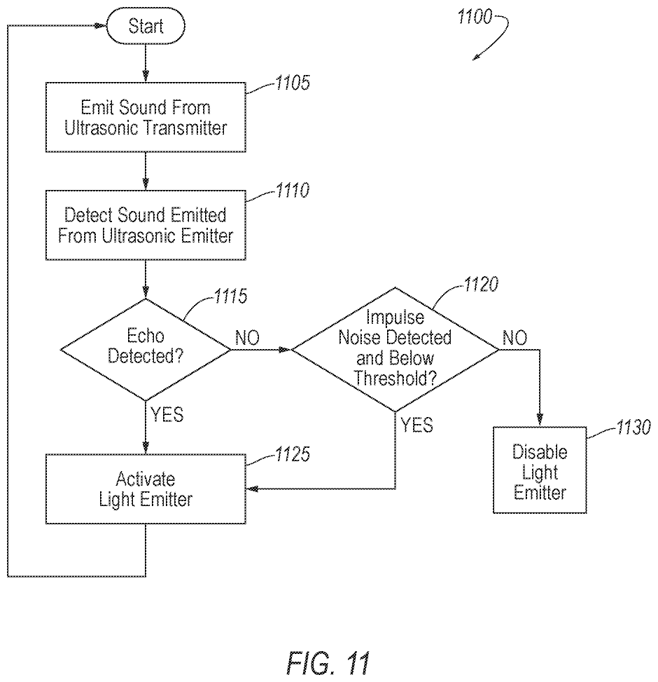

As set forth above, the controller 32 is programmed to perform the method 1100 shown in FIG. 11. With reference to FIG. 11, the method 1100 includes controlling the light emitter 14 based on confirmation, or lack thereof, of the integrity of the optical element 36, 38, i.e., whether the optical element 36, 38 is intact or damaged.

With reference to block 1105, the method 1100 includes emitting sound from the ultrasonic transmitter 18. Specifically, the controller 32 instructs the ultrasonic transmitter 18 to emit sound into the optical element 36, 38, as described above.

With reference to block 1110, the method 1100 includes detecting sound emitted from the ultrasonic transmitter 18 with the ultrasonic receiver 20. Specifically, as described above, either the sound emitted from the ultrasonic transmitter 18 into the optical element 36, 38 is reflected by the opposite side of the optical element 36, 38 to the ultrasonic receiver 20 so that the ultrasonic receiver 20 detects an echo of the sound emitted by the ultrasonic transmitter 18 or the sound emitted from the ultrasonic transmitter 18 into the optical element 36, 38 is scattered by a damaged area, e.g., a crack, of the optical element 36, 38 so that the ultrasonic receiver 20 detects impulse noise generated by the scattering of the sound.

The method 1100 includes controlling operation of the light emitter 14 aimed at the optical element 36, 38 based on characteristics of the detected sound from the ultrasonic transmitter 18. For example, in block 1115, the method 1100 includes determining whether the echo of the sound emitted by the ultrasonic transmitter 18 is detected. Specifically, the ultrasonic detector and/or the controller 32 may determine whether the echo is detected by the ultrasonic detector. In the event the echo is detected, the method 1100 proceeds to block 1125, as described further below. In the event the echo is not detected, the method 1100 proceeds to block 1120.

In block 1120, the method 1100 includes determining whether impulse noise from sound emitted by the ultrasonic transmitter 18 is detected. If the impulse noise is detected, block 1120 includes determining whether the impulse noise has characteristics indicating damage to the optical element 36, 38 to a severity of which the optical element 36, 38 may emit light from the light emitter 14 at an undesired intensity. Specifically, the method 1100 includes comparing the detected impulse noise to a predetermined threshold and disabling the light emitter 14 when the detected impulse noise is above the predetermined threshold. For example, block 1120 determines whether the impulse noise is below the predetermined frequency threshold, as described above. In the event the impulse noise indicates that the damage to the optical element 36, 38 is of a severity such that the optical element 36, 38 may emit light from the light emitter 14 at an undesired intensity. The method 1100 includes disabling the light emitter 14, as shown in block 1130. In block 1130, disabling the light emitter 14 may include, for example, preventing activation of the light emitter 14, or deciding not to provide instructions to the light emitter 14, etc., as described above. The method 1100 may include instructing the ADAS that the light emitter 14 is disabled.

The method 1100 includes enabling the light emitter 14 based on detection by the ultrasonic receiver 20 of an echo of sound generated by the ultrasonic transmitter 18. For example, in the event the impulse noise indicates that the optical element 36, 38 is intact (see block 1115) or that the optical element 36, 38 is damaged at a relatively low severity such that emission of light from the LiDAR sensor 10 is within desired intensity range (see block 1120), the method includes activating the light emitter 14. As set forth above, the controller 32 enables the light emitter 14, for example, by allowing activation of the light emitter 14, or providing instruction to the light emitter 14 to emit light, etc.

The method 1100 includes repeating the operation of the ultrasonic transmitter 18 and the ultrasonic receiver 20 to confirm the integrity of the optical element 36, 38. For example, the method 1100 may be repeated before each activation of the light emitter 14. In other words, for each firing of the light emitter 14, the method 1100 may include first activating the ultrasonic transmitter 18 to emit sound, detecting the sound with the ultrasonic receiver 20, and activating the light emitter 14 in response to identification that detection of the sound by the ultrasonic receiver 20 indicates that the optical element 36, 38 is intact. As another example, the method 1100 may include periodically repeating the operation of the ultrasonic transmitter 18 and the ultrasonic receiver 20 to confirm the integrity of the optical element 36, 38 based on time, number of light emitter 14 firings, etc.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A LiDAR sensor comprising:
an optical element;
a light emitter aimed at the optical element, the optical element directing light from the light emitter into a field of illumination;
a light detector having a field of view overlapping the field of illumination; and
an ultrasonic transmitter on the optical element and an ultrasonic receiver on the optical element.

2. The LiDAR sensor as set forth in claim 1, wherein the ultrasonic transmitter is spaced from the ultrasonic receiver.

3. The LiDAR sensor as set forth in claim 1, wherein the optical element includes a base layer and a second layer encapsulating the ultrasonic transmitter and the ultrasonic receiver on the base layer.

4. The LiDAR sensor as set forth in claim 1, wherein:
the optical element includes a light-shaping region;
the light emitter is aimed at the light-shaping region; and
the light-shaping region is between the ultrasonic transmitter and the ultrasonic receiver.

5. The LiDAR sensor as set forth in claim 1, wherein the optical element is a diffuser.

6. The LiDAR sensor as set forth in claim 5, further comprising another diffuser between the diffuser and the light emitter.

7. The LiDAR sensor as set forth in claim 1, wherein the optical element has a base layer having an inboard side and an outboard side, the ultrasonic transmitter and the ultrasonic receiver being aimed through the optical element at the inboard side.

8. The LiDAR sensor as set forth in claim 7, wherein the optical element includes a second layer on the outboard side of the base layer, the ultrasonic transmitter and the ultrasonic receiver being on the outboard side of the base layer, the second layer encapsulating the ultrasonic transmitter and the ultrasonic receiver on the outboard side of the base layer.

9. The LiDAR sensor as set forth in claim 1, further comprising a controller programmed to control operation of the light emitter based on characteristics of sound emitted from the ultrasonic transmitter and detected by the ultrasonic receiver.

10. The LiDAR sensor as set forth in claim 1, further comprising a controller programmed to disable the light emitter based on detection of impulse noise by the ultrasonic receiver generated from sound emitted by the ultrasonic transmitter and scattered by a crack in the optical element.

11. The LiDAR sensor as set forth in claim 10, wherein the controller is programmed to disable the light emitter when the detected impulse noise is above a predetermined threshold.

12. The LiDAR sensor as set forth in claim 1, further comprising a controller programmed to enable the light emitter based on detection by the ultrasonic receiver of an echo of sound emitted from the ultrasonic transmitter.

13. The LiDAR sensor as set forth in claim 12, further comprising a controller programmed to disable the light emitter based on detection of impulse noise by the ultrasonic receiver generated from sound emitted by the ultrasonic transmitter and scattered by a crack in the optical element.

14. A method of operating a LiDAR sensor, the method comprising:
emitting sound from an ultrasonic transmitter on an optical element;
detecting sound emitted from the ultrasonic transmitter with an ultrasonic receiver on the optical element;
controlling operation of a light emitter aimed at the optical element based on characteristics of the detected sound from the ultrasonic transmitter.

15. The method as set forth in claim 14, wherein controlling operation of the light emitter includes disabling the light emitter based on detection by the ultrasonic receiver of impulse noise generated from sound emitted by the ultrasonic transmitter and scattered by a crack in the optical element.

16. The method as set forth in claim 15, wherein controlling operation of the light emitter includes comparing the detected impulse noise to a predetermined threshold and disabling the light emitter when the detected impulse noise is above the predetermined threshold.

17. The method as set forth in claim 14, wherein controlling operation of the light emitter includes enabling the light emitter based on detection by the ultrasonic receiver of an echo of sound generated by the ultrasonic transmitter.

18. The method as set forth in claim 17, wherein controlling operation of the light emitter includes disabling the light emitter based on detection by the ultrasonic receiver of impulse noise generated from sound emitted by the ultrasonic transmitter and diffracted by a crack in the optical element.
